(19) United States
(12) Patent Application Publication
(10) Pub. No.: US 2026/0222847 A1
(43) Pub. Date: Jul. 30, 2026

(54) SYSTEMS AND METHODS FOR SENDING DYING GASP PROTOCOL BASED PROPOSALS IN ACCORDANCE WITH WAITING TIMERS

(71) Applicant: Verizon Patent and Licensing Inc., Basking Ridge, NJ (US)

(72) Inventor: Martin SEINE, Haltern am See (DE)

(73) Assignee: Verizon Patent and Licensing Inc., Basking Ridge, NJ (US)

(21) Appl. No.: 19/039,141

(22) Filed: Jan. 28, 2025

(51) Int. Cl. H04W 24/04; H04L 41/0213; H04W 40/24

(52) U.S. Cl. CPC H04W 24/04; H04L 41/0213; H04W 40/24

(57) ABSTRACT

A system and method for sending a dying gasp protocol according to a waiting timer, wherein a node associated with a dying gasp mesh network may receive a dictionary of one or more nodes in a wireless network. The node may determine an index based on the dictionary. The node may transmit, after a power outage, a proposal associated with a dying gasp protocol based on an expiry of a waiting timer, wherein the waiting timer is based on the index.

### BACKGROUND

Communication systems are widely deployed to provide various telecommunication services such as telephony, video, data, messaging, and broadcasts. A network may include one or more network devices that support communication for wireless communication devices.

### BRIEF DESCRIPTION OF THE DRAWINGS

FIG. 1 is a diagram of an example associated with sending dying gasp protocol based proposals in accordance with waiting timers.

FIG. 2 is a diagram of an example associated with a bitfield.

FIG. 3 is a diagram of an example associated with a hello packet.

FIG. 4 is a diagram of an example associated with a hello packet.

FIG. 5 is a diagram of an example associated with a dictionary.

FIG. 6 is a diagram of an example associated with a proposal associated with a dying gasp protocol.

FIG. 7 is a diagram of an example environment in which systems and/or methods described herein may be implemented.

FIG. 8 is a diagram of example components of one or more devices of FIG. 7.

FIG. 9 is a flowchart of an example process associated with sending dying gasp protocol based proposals in accordance with waiting timers.

### DETAILED DESCRIPTION OF EXAMPLE EMBODIMENTS

The following detailed description of example implementations refers to the accompanying drawings. The same reference numbers in different drawings may identify the same or similar elements.

In a wireless network, a device (e.g., a network component) may fail due to an inadvertent powering down of the network device. The device may be powered down for various reasons, such as a grid outage, a blown fuse, and/or a disconnected plug. A facility may address the grid outage by implementing an uninterruptible power supply. The uninterruptible power supply may only be more common in larger sites and may not protect against some reasons for powering down, such as the blown fuse and/or the disconnected plug. Further, the uninterruptible power supply may not be integrated with a managed network infrastructure, which may result in longer grid outages when devices are shut off due to the uninterruptible power supply running out of battery power. When the devices are shut off, a remote service desk may still not receive information regarding a reason for the device being down. A larger, multi-location network may experience a partial power outage, which may be due to the grid outage, the blown fuse, and/or the disconnected plug. The managed network infrastructure, which may include a central management entity, may be unable to determine the reason for which certain devices or parts of the wireless network have failed when devices are without power.

With a traditional dying gasp technology, a notification signal may be sent by a device to the network management infrastructure, where the notification signal may be sent to alert the network management infrastructure that the device is about to lose power. The device may send the notification signal prior to the device completely shutting down. The notification signal may be sent via a simple network management protocol, which may be considered to be a dying gasp network protocol. When the device detects a power failure, the device may use remaining power to send the notification signal.

With the traditional dying gasp technology, the device may send the notification signal to a controller in the case of power loss. The device may have some specific circuitry with a residual power capacity, such that the signal may be sent without external power. The dying gasp technology may have a dependency on a communication path and an availability of the controller, so the dying gasp technology may utilize a cellular network, where the controller may be a remote host in a cloud environment. The dying gasp technology may be well suited for small sites or for a monitor station in a remote site, as only a single device may be used to monitor a main power.

The traditional dying gasp technology may be suitable for single devices but may not be suitable for relatively large installations (e.g., a wireless local area network (LAN) of an office building or a campus network). For relatively large installations, each device would need to separately employ the dying gasp technology including suitable communication hardware to indicate whether the device is about to lose power. Notification signals may be sent per device, but such notification signals would not signal information about loss of power across a whole facility with respect to specific areas (e.g., specific floors) of the facility. Each device would need to be equipped with hardware that supports the dying gasp technology and communication thereof, which may be prohibitively expensive (e.g., hundreds of devices in a large installation would need to be equipped with dying gasp communication hardware). Further, during a power outage, a number of devices may lose power at the same time, and each device may separately send a notification signal to the network management infrastructure. When multiple notification signals are sent at nearly the same time, signal collisions may occur and some notification signals may not be successfully received by the network management infrastructure. In this case, the network management infrastructure may be unaware that certain devices have lost power. Thus, attempting to utilize the dying gasp technology for relatively large installations may degrade an overall system performance.

In some implementations, devices in a wireless network (e.g., wireless local area network (WLAN) devices) may form a dying gasp mesh and inform a network management infrastructure about partial or complete power outages, without the need for extensive additional hardware. A mesh network may be established with existing infrastructure equipment as an underlay for a meshed dying gasp infrastructure. The devices may be equipped with a radio, such as Bluetooth Low Energy (BLE), long range (LoRA), or a similar type of radio. The devices may include radio access points (e.g., wireless LAN access points), switches, and/or other types of network components. In a relatively large installation, such devices may be spread across a whole site. For example, each building floor may have a number of such devices. The devices may utilize BLE (or another radio technology) and a corresponding protocol to form the dying gasp mesh, where all devices in the wireless network may be used as sensors for power outages. The formation of the dying gasp mesh may allow for specific signaling regarding a loss of power across a whole facility, where the signaling may indicate outages on specific floors or specific outages on single devices, and where the signaling may indicate whether energy saving measurements take effect. A central management system and a power management system may be able to identify, with a single dying gasp uplink, if single devices, devices associated with a part of a floor, devices associated with a complete floor, and/or devices associated with a complete building are failing due to power loss. Further, the protocol may define a timing scheme that allows the devices to indicate power loss at separate times, which may avoid congestion after the power loss. In other words, multiple devices may not send notifications at the same time, which would otherwise cause a collision and a possibility that some notifications are not successfully received by the network management infrastructure.

In some implementations, by enabling the devices to create the dying gasp mesh (e.g., a facility-based dying gasp mesh) to implement the corresponding protocol, a relatively large number of devices in an installation may be able to efficiently report power loss to the network management infrastructure. Each device may be used as a sensor for detecting a power outage, which may allow for the specific signaling about the loss of power. The dying gasp mesh may be different than individual devices (e.g., non-mesh devices) that are able to transmit dying gasp notifications to a controller. Since the devices are already equipped with radios, employing the dying gasp mesh may not be overly complex. Further, by implementing the protocol that allows for the devices to transmit power loss notifications at different times, signal collisions may be avoided, and the network management infrastructure may be more likely to successfully receive notifications from the devices. The devices may each be configured with a separate slot, which may allow the devices to send power loss notifications at different times from each other, which may avoid a radio storm in which the devices all communicate at the same time. Thus, enabling the devices to create the dying gasp mesh and implement the corresponding protocol may improve an overall system performance.

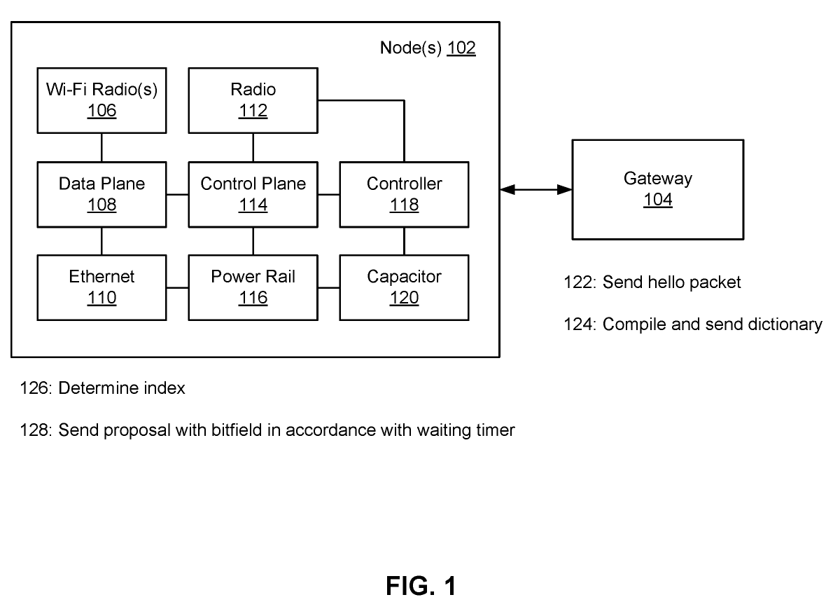

FIG. 1 is a diagram of an example 100 associated with sending dying gasp protocol based proposals in accordance with waiting timers. As shown in FIG. 1, example 100 includes one or more nodes 102 and a gateway 104. A node 102 may be a dying gasp node (DGN). The node 102 may be a wireless access point, such as a wireless LAN access point. Alternatively, the node 102 may be a switch or another type of network component. The gateway 104 may be a dying gasp gateway (DGG). The one or more nodes 102 and the gateway 104 may communicate with each other via a wireless network in a site (e.g., a building or multiple adjacent buildings). The one or more nodes 102 may be associated with a dying gasp mesh.

In some implementations, the node 102 may include or be associated with one or more Wi-Fi radios 106, a data plane 108, Ethernet 110, a radio 112 (e.g., a low power radio such as a BLE radio), a control plane 114, a power rail 116, a controller 118, and a capacitor 120. The controller 118 may be a dying gasp controller (DGC). The capacitor 120 may be a gold capacitor or any other suitable type of capacitor. During a power outage, the one or more Wi-Fi radios 106 may be non-functional. During the power outage, the radio 112 may be powered separately via the capacitor 120. A residual power stored on the capacitor 120 may be used to power the node 102 immediately after the power outage. For example, residual power may be available for 5, 10, or 20 seconds after the power outage, at which point the residual power may no longer be available. In some cases, the radio 112 may be powered via a rechargeable battery. The capacitor 120 may be maintenance free and may provide a faster recharge over the rechargeable battery. Energy stored on the capacitor 120 may need to be sufficient to run the radio 112 for a time t_{d}. During a normal operation of the node 102 (e.g., when the power outage is not present), a power source for the node 102 is via the power rail 116, which may handle power sources, such as a power supply unit (PSU), power over Ethernet (PoE), or another power source. The controller 118 may be separately connected to the power rail 116 to detect power outages. The controller 118 may have a connection to the control plane 114, which may be necessary during normal operations and may allow the controller 118 to be switched off when the node 102 is remotely switched off, which is not a power outage situation.

In some implementations, the gateway 104 may be one access point with a secured power connected to a cellular gateway, or the gateway 104 may be a dedicated device that includes Ethernet, a radio such as a BLE radio, a cellular gateway, and/or a controller (e.g., DGC). At least one device on site may need to be the gateway 104. In some cases, the gateway 104 may not have the cellular gateway, but as a grid outage may affect transmission equipment as well, the gateway 104 may be configured to terminate a fiber cable directly (e.g., a fiber home router). The gateway 104 may include software to support a gateway functionality and/or a node functionality. The gateway 104 may be associated with a backhaul. The backhaul may be associated with a power outage adverse technology, such as fiber, or the backhaul may be associated with cellular.

In some implementations, in a normal operation, a node 102 and the gateway 104 may communicate with each other. The node 102 may be any participating device that is capable of sending a dying gasp signal. The gateway 104 may be a device that is capable of receiving the dying gasp signal. The dying gasp signal, which may be sent in case of a power outage, may include a proposal, such as a dying gasp proposal (DGP). The proposal may be processed by the gateway 104 to create a dying gasp status message for a control unit outside of the wireless network. The gateway 104 may communicate with the controller 118 via cellular, fiber, and/or Ethernet.

In some implementations, as shown by reference number 122, the gateway 104 may regularly send a hello packet, which may be processed by the nodes 102. The hello packet may be a dying gasp hello (DGH), which may initially be generated by the gateway 104. The hello packet may be a special message used to synchronize all of the nodes 102 on specific parameters and provide spanning tree information for the gateway 104. After sending the hello packet to the nodes 102, the gateway 104 may compile a dictionary, such as a dying gasp dictionary (DGD). The dictionary may be a collection of information about all participating nodes 102. As shown by reference number 124, the gateway 104 may compile the dictionary, and then send the dictionary to all participating nodes 102. The participating nodes 102 may be listed in the dictionary. The dictionary may be required for determining a timing and a mapping of a bitfield, such as a dying gasp bitfield (DGB). The bitfield may be a collection of single-bit power outage information per node 102.

In some implementations, as shown by reference number 126, the node 102 may determine an index i_{N} associated with the node 102 (e.g., the node 102 may determine its own index) based on the dictionary received from the gateway 104. The node 102 may store the index and an empty bitfield may be created. The bitfield may have at least one bit for every entry in the dictionary. The node 102 may constantly listen for proposals received via a radio of the node 102, where the proposals may be received from other nodes 102. When the proposal is received at the node 102, an embedded node medium access control (MAC) may be verified against the dictionary stored on the node 102. When the node 102 is not listed in the dictionary, the proposal may be dropped. Each proposal may have an embedded bitfield, which may be added to the dictionary via a bitwise OR function, and which may cause all “1” bits to be set to “1” in an internal bitfield. When the proposal is obtained, a timer may be started for a waiting time t_{w}. The waiting time may be determined based on an index i_{N} of the node 102, where the index may be based on the dictionary. The index may be a bit index value representing an actual node 102 in the bitfield. The waiting time may be determined based on the index, a highest bit index i_{B} set in the proposal, and/or a base time t_{B}. The highest bit index may be a bit index value in the bitfield. The base time may be a base time interval, which may depend on a radio technology used. When the highest bit index is greater than the index (e.g., i_{B} > i_{N}), the node 102 may purge the proposal and resume the normal operation. Otherwise, the waiting time may be equal to the base time multiplied by a difference between the index and the highest bit index (e.g., t_{w} = (i_{N} – i_{B}) × t_{B}). When the waiting time has expired, the node 102 may send, to the gateway 104, its proposal with the stored bitfield and its own node MAC via the radio 112. The bitfield may have one or more bits from received proposals, but a bit representing the node 102 itself may be 0, as the node 102 does not experience the power outage during the normal operation.

In some implementations, after the proposal is sent, the bitfield may be reset to zero and the normal operation may resume. With sending the proposal, another timer (t_{D}) may be started, which may be in accordance with t_{D} = n × t_{B}, where n is a maximum number of supported nodes 102 in the dying gasp mesh, which may determine a size of the bitfield and the dictionary. Until the other timer has expired, no other proposal may be received and processed by the node 102. By incorporating timers at the nodes 102, multiple nodes 102 may not send dying gasp signals to the gateway 104 at the same time, which may avoid a radio storm at the gateway 104.

In some implementations, during the power outage, the node 102 may set its own bit in the stored bitfield, where the bit may be determined by the index from the dictionary received during the normal operation. All other processing in the node 102 may be halted and components of the node 102 may be switched off. At this point, only the controller 118 may be running in the node 102, where the controller 118 may be responsible for receiving and sending the proposal (dying gasp signal) via the radio 112. The waiting timer t_{w} may be set in accordance with: t_{w} = i_{N} × t_{B}). All received proposals may be processed as for the normal operation. The embedded bitfield may be applied to the stored bitfield via the bitwise OR function. As shown by reference number 128, when the waiting timer has expired, the node 102 may send the proposal with the stored bitfield, and then the node 102 may be switched off.

In some implementations, as part of a gateway operation, the gateway 104 may send, in regular intervals, the hello packet via a radio associated with the gateway 104. The node 102 may process the hello packet. The node 102 may send, via a transport control protocol (TCP) connection over Ethernet (not radio), a processed hello packet back to the gateway 104. The gateway 104 may create a spanning tree of the node 102 of a system based on the processed hello packet. A TCP or Internet Protocol (IP) (TCP/IP) connection may enable the gateway 104 to serialize the processed help packet sent over the air, which may allow for the packet storm to be avoided. When a reporting node 102 is included in an existing dictionary in a memory of the gateway 104, that dictionary may be sent to the node 102 over an open TCP/IP connection.

In some implementations, based on the spanning tree of the node 102, the gateway 104 may compile the dictionary and store the dictionary in the memory of the gateway 104. The gateway 104 may store, except after startup, two dictionaries in the memory. The two dictionaries may include an actual dictionary that is created during an actual hello phase and a last dictionary which is compiled after a last hello phase. The last dictionary may be distributed to the node 102 during a hello phase. As a result, the dictionary that is distributed may be from one hello phase back. The hello phase may end when no node 102 reports to the gateway 104 during a t_{B} waiting time. The gateway 104 may maintain a bitfield at every other node 102. For example, the bitfield may be usually all 0. When the power outage is detected, which may vary depending on a type of gateway 104, the gateway 104 may set a gateway bit in the bitfield and start a waiting timer t_{w} (if the waiting timer is not already started). The waiting timer may be in accordance with: t_{w} = n × t_{B}. When the gateway 104 receives the proposal, the gateway 104 may process the proposal via a bitwise OR function and the stored bitfield. When no waiting timer is started, the waiting timer may start, which may be in accordance with: t_{w} = n × t_{B}. When the waiting timer has expired, the bitfield may be sent via a network connection to the control unit outside of the wireless network. After sending the bitfield, the gateway 104 may be switched off (in the event of a power outage), or the gateway 104 may reset the bitfield and resume the normal operation (in the event of no power outage at the gateway 104).

In some implementations, the bitfield may include n bits, where n is a maximum number of nodes 102 and gateways 104 supported in one dying gasp mesh. When additional nodes 102 are needed, additional gateways 104 may need to be deployed. An allocation of bits for the bitfield may be tied to the dictionary. The bitfield may indicate a first bit for a first node in the dictionary, a second bit for a second node in the dictionary, and so on, where a last bit may be for the gateway 104.

In some implementations, in a hello packet processing, the gateway 104 may generate the hello packet in intervals, and the hello packet may be sent via the radio of the gateway 104 to the node 102. The hello packet may contain necessary data from the gateway 104, which may include a MAC address and an IP address. The node 102, after receiving the hello packet, may check whether the hello packet already includes data of the node 102 itself. In this case, the hello packet may be dropped. Otherwise, when the hello packet does not already include data of the node 102 itself, the node 102 may add data from itself to an end of a list in the hello packet. The node 102 may establish the TCP/IP connection with the gateway 104 to send the processed hello packet back to the gateway 104 and receive the dictionary from a last hello packet cycle. After receiving the dictionary, the node 102 may send, via the radio 112, a new hello packet, which may include data from the gateway 104, the node 102, and all previous nodes 102. A back channel via TCP/IP may serialize a hello packet transmission and ensure that a radio flooding (or radio storm) is avoided.

In some implementations, as part of a hello packet construction, the hello packet may contain one or more fields, which may be identified by a single byte field header. The field header may have a 3-bit type indicator and a 4-bit length indicator, where the length indicator may count words and may be multiplied by two for a byte length following the field header. The field header may not be included in a length. A length of 0 may indicate that no payload is following, but depending on the type, another byte may be following. As part of the hello packet construction, the field header (8 bits) may include a type (3 bits) and a length (4 bits), where one bit may be associated with a future use flag.

In some implementations, various types may be defined. The type may be associated with a version of the hello packet or a proposal, and a length may indicate a protocol version not following words (e.g., two bytes). A length with most significant bit (MSB) 0 may indicate the hello packet, and a length field value with MSB 1 (1000b) may indicate a proposal associated with a power outage. A remaining 3 bits may indicate a hello packet or proposal version. The type may be associated with a dictionary indicator, which is not the hello packet. A length may indicate a protocol version not following words. The type may be associated with a gateway MAC address (with a length of 3). The type may be associated with a node MAC address (with a length of 3). The type may be associated with a gateway IP set. A length may be 2 for IP version 4 (IPv4) only, 8 for IP version 6 (IPv6) only, or 10 for IPv4 or IPv6. When IPv4 and IPv6 are used, the data may be packed. In other words, 4 bytes may be used for IPv4 and 16 bytes may be used for IPv6 with no additional header or separator. The type may be associated with an end-of-list, which may mark an end of a node MAC list. A length may be 0, but one byte may be following. A following byte of 0 may indicate that the node MAC list is complete for the node 102. When node entries have to be dropped to be within a limit of 30 node entries, a number of dropped entries may be indicated in a following byte. The limit of 30 node entries may be set to allow compatibility with specific radio types (e.g., BLE). Other implementations with other radio types may define other limits.

In some implementations, the node 102 may add its own MAC address entry to an end of a list in the hello packet, which may be before an end-of-list marker. By adding the MAC address entry, loops may be detected, and when hello packets are dropped, the gateway 104 may be able to create a vector leading to a corresponding node 102. When the list already contains 30 node entries, a first node entry may be removed before the node 102 adds its node MAC to the end of the list. A counter (e.g., a last byte in a two-byte end-of-list marker) may be increased by one.

In some implementations, as part of a dictionary compilation, the gateway 104 may receive hello packets from the nodes 102. In some cases, one node 102 may send more than one hello packet to the gateway 104. In this case, a hello packet with a shortest vector may be used. When a vector length is the same between multiple hello packets, (e.g., the vector lengths form a tie), then a first hello packet that is received among hello packets with the shortest vector may be used. In a next iteration, all vectors may be sorted by length, from a longest vector to a shortest vector. When a tie is present between vector lengths, a secondary sorting may be by MAC addresses of nodes of those vectors. A sorted list of nodes and corresponding vectors may be obtained (e.g., node A, node B, node C, and node D). The sorted list may be compiled as the dictionary, where the nodes 102 may receive the dictionary in a next hello packet cycle. The dictionary may use same field markers as the hello packet. The dictionary may start with a version indicator (or dictionary indicator) and may end with an end-of-list marker with a trailing zero byte. Each node 102 may derive the dictionary from its own index. When less than n-1 nodes are in place, empty slots may be filled with MAC address 00000000, so that a length of the dictionary is constant. The index may be utilized for the bitfield and for timing.

In some implementations, regarding a format of the proposal, the proposal that is sent in case of the power outage may be a relatively small packet. The proposal may include a bitfield MAC and a sending node MAC, which may allow for a verification that the sending node is part of an actual dictionary.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

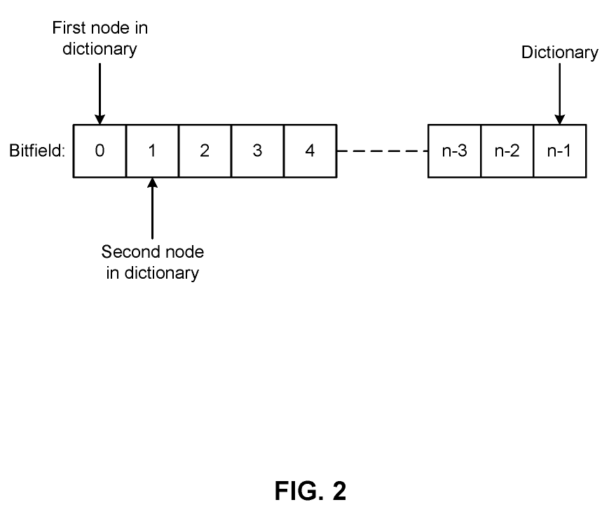

FIG. 2 is a diagram of an example 200 associated with a bitfield.

As shown in FIG. 2, the bitfield may include n bits, where n is a maximum number of nodes and gateways supported in one dying gasp mesh. The bitfield may indicate a first bit for a first node in the dictionary, a second bit for a second node in the dictionary, and so on, where a last bit may be for the gateway. The first bit may indicate an index N, which may indicate an index of a node in the dictionary starting with 0 for the first node. In this example, the first node may be associated with index 0, the second node may be associated with index 1, and so on.

As indicated above, FIG. 2 is provided as an example. Other examples may differ from what is described with regard to FIG. 2.

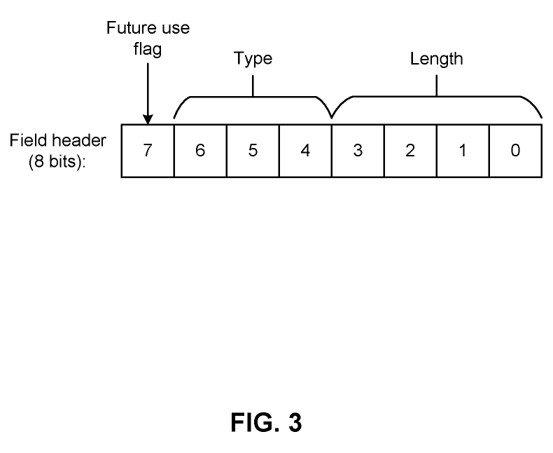

FIG. 3 is a diagram of an example 300 associated with a hello packet.

As shown in FIG. 3, the hello packet may be associated with a field header (8 bits). The field header may include a type (3 bits) and a length (4 bits), where one bit may be associated with a future use flag. The type may be associated with a version of a hello packet or a proposal, a dictionary indicator, a gateway MAC address, a node MAC address, a gateway IP set, and/or an end of a list that marks an end of a node MAC list.

As indicated above, FIG. 3 is provided as an example. Other examples may differ from what is described with regard to FIG. 3.

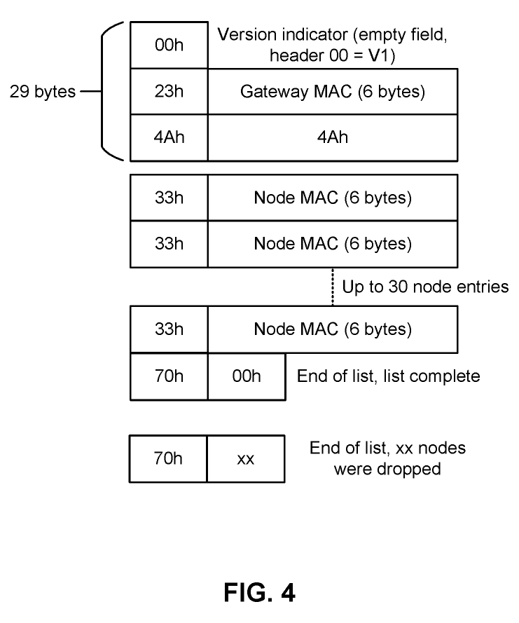

FIG. 4 is a diagram of an example 400 associated with a hello packet.

As shown in FIG. 4, one or more nodes may add respective MAC address entries to an end of a list in the hello packet, where the MAC address entries may be before an end-of-list marker. The hello packet may include a version indicator, a gateway MAC, a gateway IPv4/v6 value, one or more node MAC address entries, and the end-of-list marker. The end-of-list marker may indicate that the list is complete or that a number of nodes were dropped without being added to the list.

As indicated above, FIG. 4 is provided as an example. Other examples may differ from what is described with regard to FIG. 4.

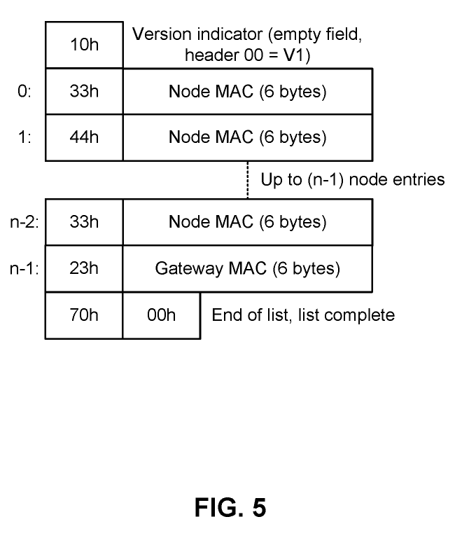

FIG. 5 is a diagram of an example 500 associated with a dictionary.

As shown in FIG. 5, the dictionary may indicate a version indicator, one or more node MAC addresses, which may be associated with n-1 node entries, and an end-of-list marker. Each node may derive the dictionary using an index associated with the node. When less than n-1 node entries are present, empty slots may be filled with MAC address 00000000, so that a length of the dictionary may be constant.

As indicated above, FIG. 5 is provided as an example. Other examples may differ from what is described with regard to FIG. 5.

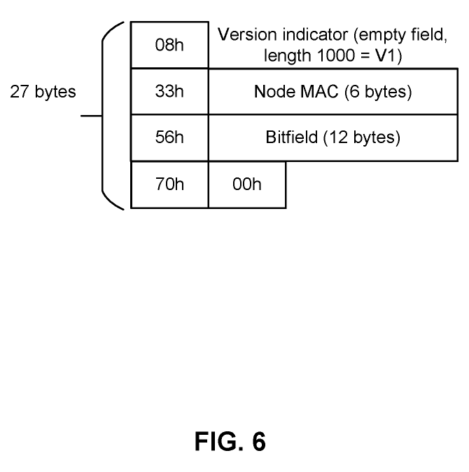

FIG. 6 is a diagram of an example 600 associated with a proposal associated with a dying gasp protocol.

As shown in FIG. 6, the proposal may include a version indicator, a node MAC, and a bitfield. The node MAC may be associated with a node that sends the proposal. An inclusion of the node MAC may allow for a verification that the node sending the proposal is part of an actual dictionary. The proposal may be included in a dying gasp message, which may be sent in case of a power outage.

As indicated above, FIG. 6 is provided as an example. Other examples may differ from what is described with regard to FIG. 6.

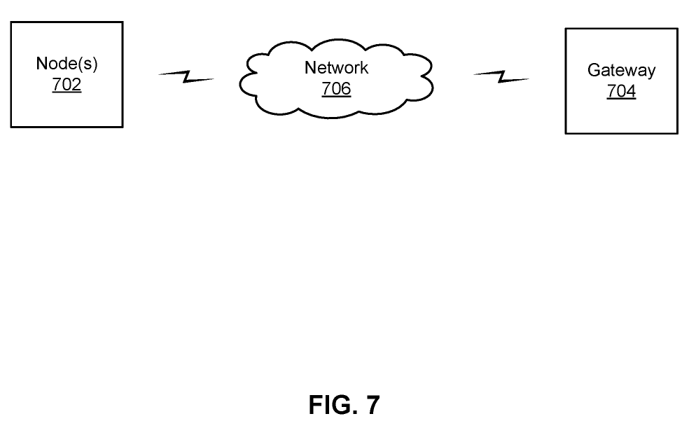

FIG. 7 is a diagram of an example environment 700 in which systems and/or methods described herein may be implemented. As shown in FIG. 7, environment 700 may include a node 702 (e.g., node 102), a gateway 704 (e.g., gateway 104), and a network 706. Devices of environment 700 may interconnect via wired connections, wireless connections, or a combination of wired and wireless connections.

The node 702 may include one or more devices capable of receiving, generating, storing, processing, and/or providing information associated with sending dying gasp protocol based proposals in accordance with waiting timers, as described elsewhere herein. The node 702 may be a DGN. The node 702 may be associated with a dying gasp protocol. The node 702 may be an access point (e.g., a wireless LAN access point), a router, a switch, a firewall, a hub, a bridge, a reverse proxy, a server, a load balancer, or a similar type of network component. The node 702 may include a radio, such as a BLE radio.

The gateway 704 may include one or more devices capable of receiving, processing, storing, routing, and/or providing information associated with sending dying gasp protocol based proposals in accordance with waiting timers, as described elsewhere herein. The gateway 704 may be a DGG. The gateway 704 may be associated with a dying gasp protocol. The gateway 704 may be an access point (e.g., a wireless LAN access point), a router, a switch, a firewall, a hub, a bridge, a reverse proxy, a server, a load balancer, or a similar type of network component. The gateway 704 may include a radio, such as a BLE radio.

The network 706 may include one or more wired and/or wireless networks. The network 706 may include a terrestrial network. For example, the network 706 may include a cellular network (e.g., a Fifth Generation (5G) network, a Fourth Generation (4G) network, a Long Term Evolution (LTE) network, a Third Generation (3G) network, a code division multiple access (CDMA) network, etc.), a public land mobile network (PLMN), a LAN, a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 706 enables communication among the devices of environment 700.

The number and arrangement of devices and networks shown in FIG. 7 are provided as an example. In practice, there may be additional devices and/or networks, fewer devices and/or networks, different devices and/or networks, or differently arranged devices and/or networks than those shown in FIG. 7. Furthermore, two or more devices shown in FIG. 7 may be implemented within a single device, or a single device shown in FIG. 7 may be implemented as multiple, distributed devices. Additionally, or alternatively, a set of devices (e.g., one or more devices) of environment 700 may perform one or more functions described as being performed by another set of devices of environment 700.

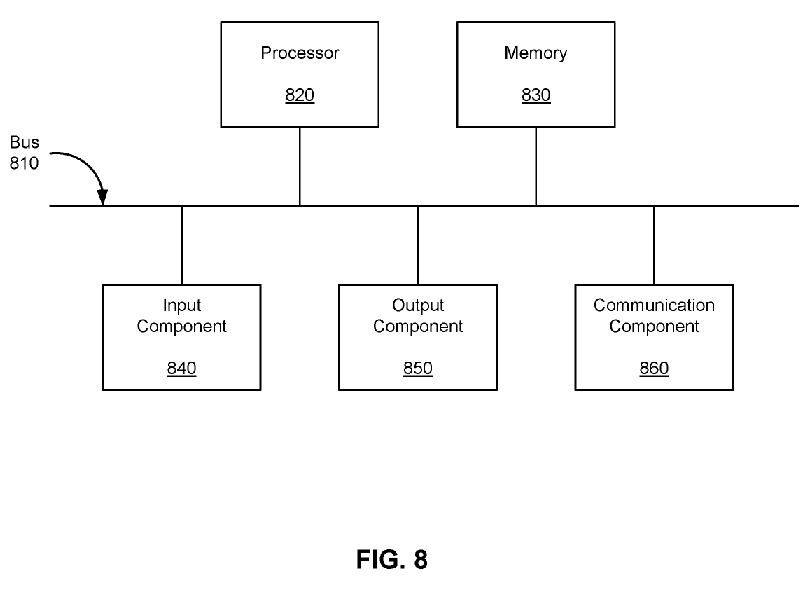

FIG. 8 is a diagram of example components of a device 800 associated with sending dying gasp protocol based proposals in accordance with waiting timers. The device 800 may correspond to a node (e.g., node 102) or a gateway (e.g., gateway 104). In some implementations, the device may include one or more devices 800 and/or one or more components of the device 800. As shown in FIG. 8, the device 800 may include a bus 810, a processor 820, a memory 830, an input component 840, an output component 850, and/or a communication component 860.

The bus 810 may include one or more components that enable wired and/or wireless communication among the components of the device 800. The bus 810 may couple together two or more components of FIG. 8, such as via operative coupling, communicative coupling, electronic coupling, and/or electric coupling. For example, the bus 810 may include an electrical connection (e.g., a wire, a trace, and/or a lead) and/or a wireless bus. The processor 820 may include a central processing unit, a graphics processing unit, a microprocessor, a controller, a microcontroller, a digital signal processor, a field-programmable gate array, an application-specific integrated circuit, and/or another type of processing component. The processor 820 may be implemented in hardware, firmware, or a combination of hardware and software. In some implementations, the processor 820 may include one or more processors capable of being programmed to perform one or more operations or processes described elsewhere herein.

The memory 830 may include volatile and/or nonvolatile memory. For example, the memory 830 may include random access memory (RAM), read only memory (ROM), a hard disk drive, and/or another type of memory (e.g., a flash memory, a magnetic memory, and/or an optical memory). The memory 830 may include internal memory (e.g., RAM, ROM, or a hard disk drive) and/or removable memory (e.g., removable via a universal serial bus connection). The memory 830 may be a non-transitory computer-readable medium. The memory 830 may store information, one or more instructions, and/or software (e.g., one or more software applications) related to the operation of the device 800. In some implementations, the memory 830 may include one or more memories that are coupled (e.g., communicatively coupled) to one or more processors (e.g., processor 820), such as via the bus 810. Communicative coupling between a processor 820 and a memory 830 may enable the processor 820 to read and/or process information stored in the memory 830 and/or to store information in the memory 830.

The input component 840 may enable the device 800 to receive input, such as user input and/or sensed input. For example, the input component 840 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 850 may enable the device 800 to provide output, such as via a display, a speaker, and/or a light-emitting diode. The communication component 860 may enable the device 800 to communicate with other devices via a wired connection and/or a wireless connection. For example, the communication component 860 may include a receiver, a transmitter, a transceiver, a modem, a network interface card, and/or an antenna.

The device 800 may perform one or more operations or processes described herein. For example, a non-transitory computer-readable medium (e.g., memory 830) may store a set of instructions (e.g., one or more instructions or code) for execution by the processor 820. The processor 820 may execute the set of instructions to perform one or more operations or processes described herein. In some implementations, execution of the set of instructions, by one or more processors 820, causes the one or more processors 820 and/or the device 800 to perform one or more operations or processes described herein. In some implementations, hardwired circuitry may be used instead of or in combination with the instructions to perform one or more operations or processes described herein. Additionally, or alternatively, the processor 820 may be configured to perform one or more operations or processes described herein. Thus, implementations described herein are not limited to any specific combination of hardware circuitry and software.

The number and arrangement of components shown in FIG. 8 are provided as an example. The device 800 may include additional components, fewer components, different components, or differently arranged components than those shown in FIG. 8. Additionally, or alternatively, a set of components (e.g., one or more components) of the device 800 may perform one or more functions described as being performed by another set of components of the device 800.

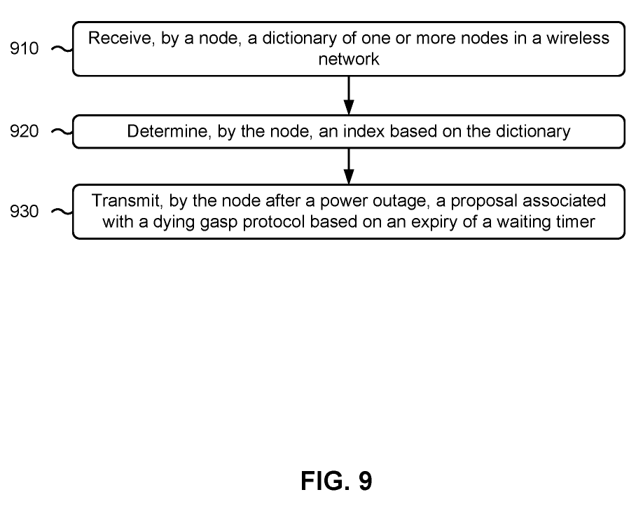

FIG. 9 is a flowchart of an example process 900 associated with sending dying gasp protocol based proposals in accordance with waiting timers. In some implementations, one or more process blocks of FIG. 9 may be performed by a node (e.g., node 102) or a gateway (e.g., gateway 104). Additionally, or alternatively, one or more process blocks of FIG. 9 may be performed by one or more components of device 800, such as processor 820, memory 830, input component 840, output component 850, and/or communication component 860.

As shown in FIG. 9, process 900 may include receiving, by the node from the gateway, a dictionary of one or more nodes in a wireless network (block 910). The dictionary may include a version indicator, one or more addresses associated with the one or more nodes, an address associated with a gateway, and an end-of-list marker. A quantity associated with the one or more nodes may be based on a maximum number of supported nodes in a dying gasp mesh. The node may be a wireless access point in the wireless network.

In some implementations, the node may receive, from the gateway, a hello packet associated with a synchronization of the one or more nodes. The node may check whether the hello packet indicates data associated with the node. The node may drop the hello packet based on the hello packet already indicating the data associated with the node. In some implementations, the node may receive, from the gateway, the hello packet. The node may check whether the hello packet indicates data associated with the node. The node may determine that the hello packet does not indicate the data associated with the node. The node may add the data associated with the node to the hello packet. The node may transmit, to the gateway, the hello packet with the data associated with the node. The dictionary may be based on the hello packet. Spanning tree information associated with the one or more nodes may be based on the hello packet. In some implementations, the hello packet may include a version indicator, an address associated with a gateway, one or more addresses associated with the one or more nodes, and an end-of-list marker.

As shown in FIG. 9, process 900 may include determining, by the node, an index based on the dictionary (block 920). The node may store the index in a memory associated with the node. Different nodes may be associated with different indexes, which may be used by the different nodes to transmit dying gasp protocol based signals at different times, thereby avoiding collisions between the one or more nodes.

As shown in FIG. 9, process 900 may include transmitting, by the node to the gateway after a power outage, a proposal associated with a dying gasp protocol based on an expiry of a waiting timer, wherein the waiting timer is based on the index (block 930). Since the different indexes may be associated with the different nodes, different waiting timers may be utilized by the different nodes, which may ensure that multiple nodes do not transmit at the same time. The node may transmit the proposal using a component that stores residual power. The proposal may indicate a bitfield and an address associated the node. The bitfield may include a collection of single-bit power outage information per node. The bitfield may be based on a number of bits that corresponds to a maximum quantity associated with the one or more nodes. The one or more nodes may be associated with a dying gasp mesh. Each bit in the bitfield may be associated with one node of the one or more nodes.

In some implementations, the proposal may be a first proposal and the node may be a first node. The first node may receive, from the gateway during a normal operation that is outside of the power outage, a second proposal associated with a second node of the one or more nodes. In some implementations, the first node may determine that the second node is not indicated in the dictionary. The first node may drop the second proposal. Alternatively, the first node may start the waiting timer, where the waiting timer may be based on the index, a highest bit index set in the second proposal, and a base time. The first node may transmit, to the gateway based on an expiry of the waiting timer, a third proposal. The third proposal may indicate a bitfield with a value indicating that the first node is not experiencing the power outage.

Although FIG. 9 shows example blocks of process 900, in some implementations, process 900 may include additional blocks, fewer blocks, different blocks, or differently arranged blocks than those depicted in FIG. 9. Additionally, or alternatively, two or more of the blocks of process 900 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a node, a dictionary of one or more nodes in a wireless network;
determining, by the node, an index based on the dictionary; and
transmitting, by the node after a power outage, a proposal associated with a dying gasp protocol based on an expiry of a waiting timer, wherein the waiting timer is based on the index.

2. The method of claim 1, wherein the proposal indicates a bitfield and an address associated the node, and wherein the bitfield includes a collection of single-bit power outage information per node.

3. The method of claim 2, wherein the bitfield is based on a number of bits that corresponds to a maximum quantity associated with the one or more nodes, wherein the one or more nodes are associated with a dying gasp mesh, and wherein each bit in the bitfield is associated with one node of the one or more nodes.

4. The method of claim 1, wherein the proposal is a first proposal and the node is a first node, and further comprising:
receiving, by the node and during a normal operation that is outside of the power outage, a second proposal associated with a second node of the one or more nodes;
determining, by the node, that the second node is not indicated in the dictionary; and
dropping, by the node, the second proposal.

5. The method of claim 1, wherein the proposal is a first proposal and the node is a first node, and further comprising:
receiving, by the node and during a normal operation that is outside of the power outage, a second proposal associated with a second node of the one or more nodes;
starting, by the node, the waiting timer, wherein the waiting timer is based on the index, a highest bit index set in the second proposal, and a base time; and
transmitting, by the node and based on an expiry of the waiting timer, a third proposal, wherein the third proposal indicates a bitfield with a value indicating that the node is not experiencing the power outage.

6. The method of claim 1, further comprising:
receiving, by the node, a packet associated with a synchronization of the one or more nodes;
checking, by the node, whether the packet indicates data associated with the node; and
dropping, by the node, the packet based on the packet already indicating the data associated with the node.

7. The method of claim 1, further comprising:
receiving, by the node, a packet associated with a synchronization of the one or more nodes;
checking, by the node, whether the packet indicates data associated with the node;
determining, by the node, that the packet does not indicate the data associated with the node;
adding, by the node, the data associated with the node to the packet; and
transmitting, by the node, the packet with the data associated with the node, wherein the dictionary is based on the packet, and wherein spanning tree information associated with the one or more nodes is based on the packet.

8. The method of claim 1, further comprising:
receiving, by the node, a packet associated with a synchronization of the one or more nodes, wherein the packet includes a version indicator, an address associated with a gateway, one or more addresses associated with the one or more nodes, and an end-of-list marker.

9. The method of claim 1, wherein the dictionary includes a version indicator, one or more addresses associated with the one or more nodes, an address associated with a gateway, and an end-of-list marker, and wherein a quantity associated with the one or more nodes is based on a maximum number of supported nodes in a dying gasp mesh.

10. The method of claim 1, wherein the node is a wireless access point in the wireless network, and wherein the node includes a component that stores residual power for transmitting the proposal after the power outage.

11. A node, comprising:
one or more processors configured to:
receive a dictionary of one or more nodes in a wireless network;
determine an index based on the dictionary; and
transmit, after a power outage, a proposal associated with a dying gasp protocol based on an expiry of a waiting timer, wherein the waiting timer is based on the index.

12. The node of claim 11, wherein the proposal indicates a bitfield and an address associated the node, and wherein the bitfield includes a collection of single-bit power outage information per node.

13. The node of claim 12, wherein the bitfield is based on a number of bits that corresponds to a maximum quantity associated with the one or more nodes, wherein the one or more nodes are associated with a dying gasp mesh, and wherein each bit in the bitfield is associated with one node of the one or more nodes.

14. The node of claim 11, wherein the proposal is a first proposal and the node is a first node, and wherein the one or more processors are further configured to:
receive, during a normal operation that is outside of the power outage, a second proposal associated with a second node of the one or more nodes;
determine that the second node is not indicated in the dictionary; and
drop the second proposal.

15. The node of claim 11, wherein the proposal is a first proposal and the node is a first node, and wherein the one or more processors are further configured to:
receive, during a normal operation that is outside of the power outage, a second proposal associated with a second node of the one or more nodes;
start the waiting timer, wherein the waiting timer is based on the index, a highest bit index set in the second proposal, and a base time; and
transmit, based on an expiry of the waiting timer, a third proposal, wherein the third proposal indicates a bitfield with a value indicating that the node is not experiencing the power outage.

16. The node of claim 11, wherein the one or more processors are further configured to:
receive a hello packet associated with a synchronization of the one or more nodes;
check whether the hello packet indicates data associated with the node; and
drop the hello packet based on the hello packet already indicating the data associated with the node.

17. The node of claim 11, wherein the one or more processors are further configured to:
receive a hello packet associated with a synchronization of the one or more nodes;
check whether the hello packet indicates data associated with the node;
determine that the hello packet does not indicate the data associated with the node;
add the data associated with the node to the hello packet; and
transmit the hello packet with the data associated with the node, wherein the dictionary is based on the hello packet, and wherein spanning tree information associated with the one or more nodes is based on the hello packet.

18. The node of claim 11, wherein the one or more processors are further configured to:
receive a hello packet associated with a synchronization of the one or more nodes, wherein the hello packet includes a version indicator, an address associated with a gateway, one or more addresses associated with the one or more nodes, and an end-of-list marker.

19. The node of claim 11, wherein the dictionary includes a version indicator, one or more addresses associated with the one or more nodes, an address associated with a gateway, and an end-of-list marker, and wherein a quantity associated with the one or more nodes is based on a maximum number of supported nodes in a dying gasp mesh.

20. A non-transitory computer-readable medium storing a set of instructions, the set of instructions comprising:
one or more instructions that, when executed by one or more processors of a node, cause the node to:
receive a dictionary of one or more nodes in a wireless network;
determine an index based on the dictionary; and
transmit, after a power outage, a proposal associated with a dying gasp protocol based on an expiry of a waiting timer, wherein the waiting timer is based on the index.
